(19) United States
(12) Patent Application Publication
(10) Pub. No.: US 2004/0119833 A1
(43) Pub. Date: Jun. 24, 2004

(54) Three-dimensional context sensitive scanner

(76) Inventors: Donald D. Duncan, Silver Springs, MD (US); Bradley G. Boone, Columbia, MD (US); Kevin C. Baldwin, Columbia, MD (US)

Correspondence Address: Francis A. Cooch, Office of Patent Counsel, THE JOHNS HOPKINS UNIVERSITY, Applied Physics Laboratory, 11100 Johns Hopkins Road, Laurel, MD, 20723-6099, US

(21) Appl. No.: 10/624,212

(22) Filed: Jul. 22, 2003

Related U.S. Application Data
(60) Provisional application No. 60/398,709, filed on Jul. 25, 2002.

(51) Int. Cl. H04N 5/225

(52) U.S. Cl. 348/207.99

(57) ABSTRACT

A system and method of scanning an artifact is disclosed. A single CCD can be configured to obtain color image data for the artifact using conventional imagery, gross shape data using a three-dimensional scanning technique, and high resolution shape data using an amplitude modulated laser scanning technique. A software driven computer processor controls the CCD and a series of illumination projectors to obtain color and gross shape data for an artifact. Algorithms then determine areas of the artifact that need to be scanned at a higher resolution. These areas are then re-scanned using an amplitude modulated laser scanning system. Once the entire artifact has been scanned completely, the color, gross shape, and high resolution shape data is combined into a single image file representative of the artifact. The key advancement is the ability of the present invention to dynamically determine areas of the artifact that require high resolution scans. Thus, only portions of the artifact need to be laboriously scanned while the gross shape data for the rest of the artifact suffices. The result is a significant reduction in time and storage requirements for creating and archiving image files for artifacts.

### CROSS REFERENCE TO RELATED APPLICATIONS

This application is related to and claims the benefit of U.S. Provisional Patent Application Serial No. 60/398,709, filed Jul. 25, 2002 entitled “Three-Dimensional Scanner for Archeological Artifacts”.

### BACKGROUND

Presently, the process of scanning and imaging archeological artifacts is a painstaking time-consuming endeavor that requires significant amounts of electronic storage to hold a true image of the artifact scanned. Three dimensional scanning techniques for archeological artifacts need to be very robust. The degree of precision desired by those in the field requires image resolution be on the order of 10's of micro-meters. Moreover, lighting is an important consideration when scanning an artifact. High resolution, 360 degree views, and multiple lighting levels all factor into extremely large electronic files. Even with broadband speed network connections, some of these images can take a prohibitive amount of time to load onto a computer for viewing. While the technology exists to perform the requisite tasks, the current methods do not allow for easy and efficient widespread use and access since image file sizes are extremely large. As a result, the idea of cataloguing archeological artifacts into an electronic library that can be accessed by anyone on a computer network is not currently feasible.

Thus, a goal of the present invention is to minimize data acquisition time and data storage requirements so that scanned images can be electronically catalogued and accessed easily and efficiently.

### SUMMARY

The present invention is a high resolution dynamically adjustable three dimensional scanning system that is particularly useful for scanning, imaging, and cataloguing archeological artifacts. A key feature of the present invention is its ability to reduce the image file size(s). The present invention can “compress” the file size without sacrificing image integrity by adaptively altering the imaging resolution used by the imaging device that is scanning an artifact.

A single CCD can be configured to obtain color image data for the artifact using conventional imagery, gross shape data using a three-dimensional scanning technique, and high resolution shape data using an amplitude modulated laser scanning technique. A software driven computer processor controls the CCD and a series of illumination projectors to obtain color and gross shape data for an artifact. Algorithms then determine areas of the artifact that need to be scanned at a higher resolution. These areas are then re-scanned using an amplitude modulated laser scanning system. Once the entire artifact has been scanned completely, the color, gross shape, and high resolution shape data is combined into a single image file representative of the artifact. The key advancement is the ability of the present invention to dynamically determine areas of the artifact that require high resolution scans. Thus, only portions of the artifact need to be laboriously scanned while the gross shape data for the rest of the artifact suffices. The result is a significant reduction in time and storage requirements for creating and archiving image files for artifacts.

### BRIEF DESCRIPTION OF THE DRAWINGS

FIG. 1 illustrates one embodiment of a block diagram of the present invention.

FIG. 2 is a flow chart describing the overall image data acquisition process of the present invention.

FIG. 3 is a flow chart describing the color image data acquisition process of the present invention.

FIG. 4 is a flow chart describing the gross shape image data acquisition process of the present invention.

FIG. 5 is a flow chart describing the high resolution image data acquisition process of the present invention.

### DETAILED DESCRIPTION

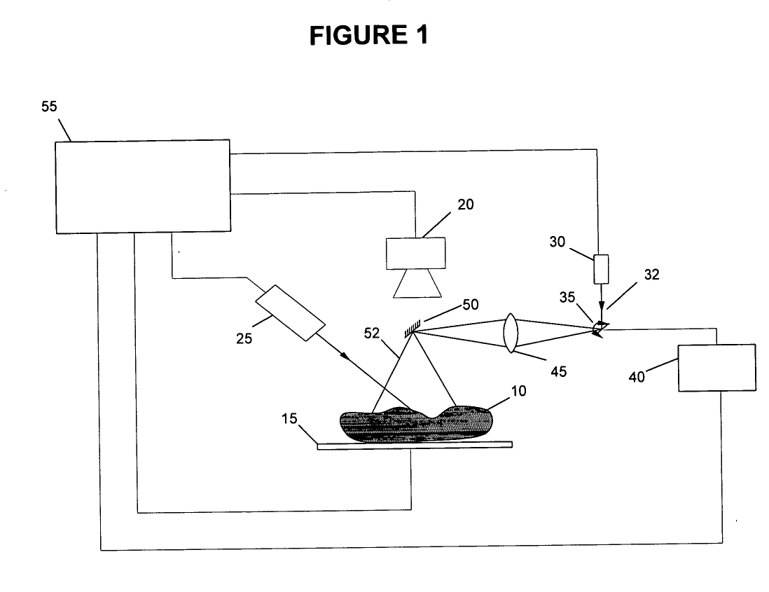

FIG. 1 illustrates a block diagram of the present invention. An artifact 10 typically includes regions of highly structured surface relief and/or color and other regions in which these physical properties are slowly varying. To minimize data acquisition time (and data storage requirements) the present invention scans highly structured regions with a dense sampling and lesser structured regions with a more sparse sampling. Positioning of artifact 10 is achieved using a motion control system comprised of one or more linear translation components and a rotational platen 15 on which the artifact 10 is placed. A slow scan area-based CCD 20 is used to capture images of the artifact 10. The slow scan area based characteristics of CCD 20 enable selection of integration time and provide greater A/D precision. Telecentric optics are used for CCD 20. CCD 20 is capable of acquiring color, gross shape, and high resolution image data.

One or more projectors 25 are required for acquiring color and gross shape. For color data acquisition, the projectors alternately emit red, green, and blue light from various angular orientations while the CCD acquires images of the artifact. One or more projectors 25 can generate structured light patterns (specifically a laser stripe or grid pattern) on artifact 10. For gross shape data acquisition, the artifact is illuminated using a photometric stereo technique or a structured light technique from various orientations and perspectives while the CCD acquires images of the artifact. This provides local surface slope information that, in the case of the photometric stereo technique, is integrated together to provide information on gross artifact shape. The structured light technique provides data that does not need to be integrated. The photometric stereo technique can acquire data faster but requires more processing computation than the structured light technique. The present invention can be implemented using either technique for acquiring gross shape data, or both.

High resolution range measurement is provided by a system 30 based on amplitude modulation and synchronous detection of an infrared laser beam (1.55 μm). As illustrated in FIG. 1, this component comprises a laser transmitter, receiver, and demodulation electronics. Range estimates are achieved by measurement of the phase (with respect to the modulation of the laser source) of a detected signal. Various range resolutions can be selected through use of different modulation frequencies.

Scanning of the range measurement beam can be provided by a galvanometer-based system. FIG. 1 illustrates a system that scans in a single direction, but two orthogonal directions also may be scanned. Closed loop positioning of galvanometer mirror(s) 35 provide information on the instantaneous lateral position of a range measurement beam 32. The galvanometer control sub-system 40 provides a means of selecting the portion of the artifact to be scanned at a prescribed resolution. A lens 45 and a turning mirror 50 fold a scan beam 52 into coaxial alignment with the CCD 20 line of sight.

In an alternative embodiment, the galvanometer mirrors 35 and galvanometer control sub-system 40 are replaced by an acousto-optic Bragg cell(s) and an acousto-optic Bragg cell control sub-system, respectively.

The entire data collection process is controlled by a processing device such as a personal computer 55. Based on the gross shape information acquired, algorithms decide on the desired scan resolutions for various regions of the artifact. Additionally, these algorithms decide the next orientation of the object. This latter feature is necessary if the local surface topology of the artifact precludes viewing or scanning of portions of the object, or if the object is sufficiently large that the entire object cannot be viewed or scanned at once.

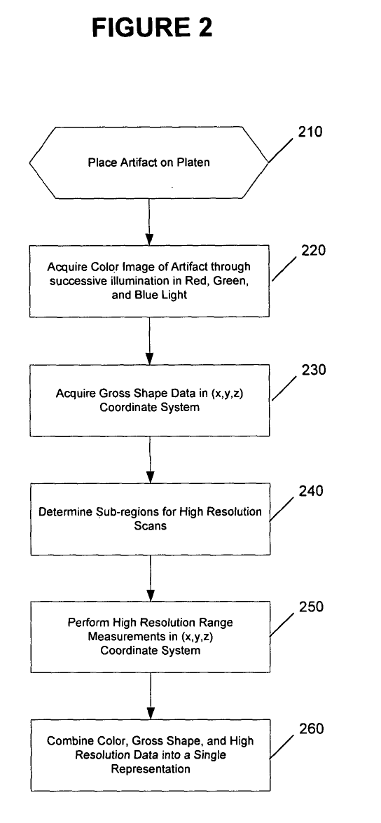

FIG. 2 is a flow chart describing the overall image data acquisition process of the present invention. The process essentially comprises three main functions. These functions can be characterized as color data acquisition, gross shape data acquisition, and high resolution shape data acquisition. A particularly novel aspect of the present invention is its ability to determine only those regions on an artifact that need high resolution scanning. By limiting the high resolution scanning to selected artifact regions, a significant time and data savings is achieved.

The first step in the process is to place the artifact on a platen 210. Illumination projectors variously placed successively illuminate the artifact with red, blue, and green light while the CCD acquires images of the artifact 220. This is the color data acquisition step. Next, gross shape data in the (x,y,z) coordinate system is obtained 230 using 3-D scanning approaches. Based on the acquired gross shape data, an algorithm determines regions of the artifact that require higher resolution scanning 240. This is followed by performing high resolution scans on the selected regions of the artifact 250. The final step is to combine color, gross shape, and high resolution data into a single image file representative of the entire artifact 260. The high resolution shape data essentially replaces the gross shape data for the selected regions. The end result is an image file that is considerably smaller than one that is comprised of all high resolution data. Moreover, the image file can be created in significantly less time. The format of the image file is consistent with those used in the art.

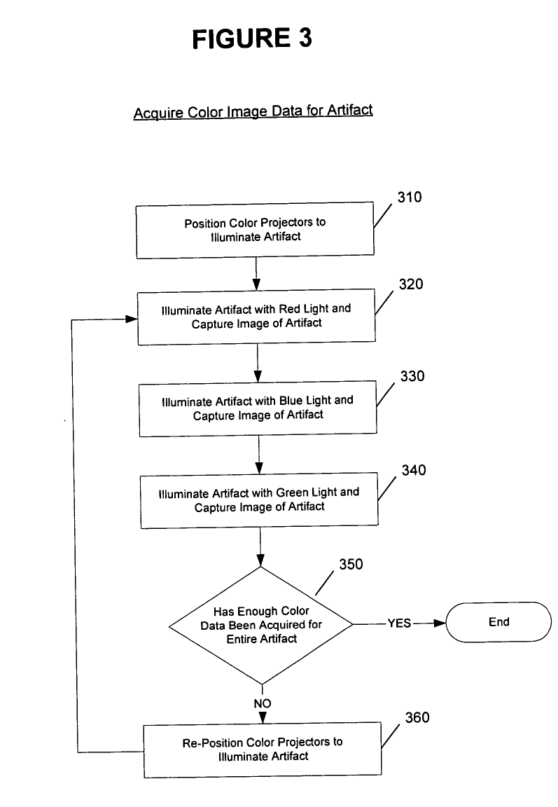

FIG. 3 is a flow chart describing the color image data acquisition process in greater detail. Once the artifact has been placed on the platen, the color illumination projectors are positioned so as to illuminate the artifact 310. The projectors then bathe the artifact in red light 320 while the CCD captures an image of the artifact. The process is then repeated using blue light 330, and finally green light 340. After each color has had a turn, an algorithm residing in the computer control system determines if enough color data has been captured for the artifact 350. If so, the color acquisition process is terminated. Otherwise, the artifact is re-positioned on the platen and the illumination/image acquisition steps are repeated 360 until enough color data has been gathered.

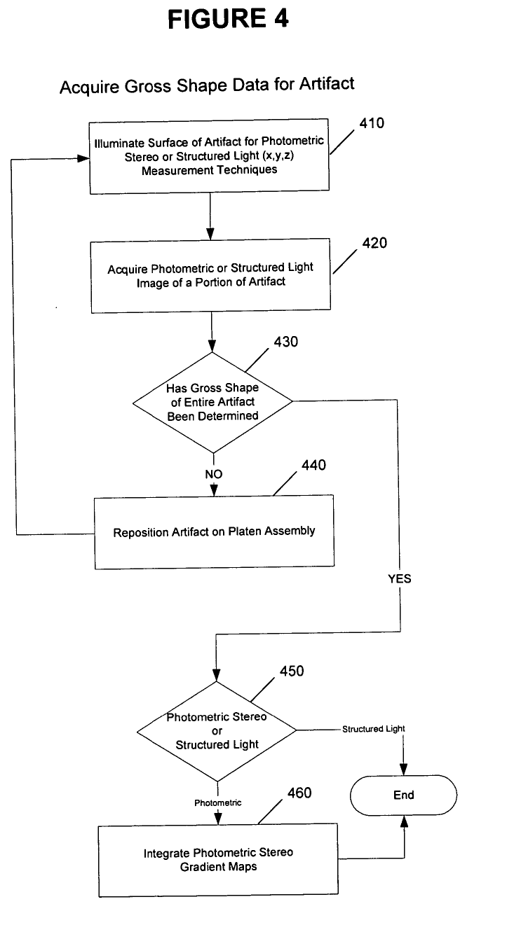

FIG. 4 is a flow chart describing the gross shape image data acquisition process in greater detail. On the basis of the conventional imagery (described in FIG. 3 above), software algorithms can assess the regions of the artifact that are highly structured and the regions that are smooth. This analysis drives the three-dimensional scanning resolution requirements for the various regions. One can also decide which three-dimensional scanning method is most appropriate.

There are at least two methods for acquiring three-dimensional gross shape data. One is to use a photometric stereo technique and the other is to use a structured light technique. As alluded to earlier, each has its own advantages over the other. The decision to use one over the other is merely a design choice.

The photometric stereo method illuminates the artifact 410 at a series of at least three known directions and takes one camera exposure 420 per illumination direction. Next, the software algorithms determine if the entire artifact has been scanned 430. If not, the artifact is re-positioned on the platen 440 and illuminated again until images for the entire artifact have been captured.

With respect to the photometric stereo method, there is a single surface tilt for a specific point on the object that is consistent with the brightness measurements observed in the series of images. In other words, photometric stereo yields a map of the local surface gradient or slope, rather than height. These surface tilts are described in terms of a polar and an azimuthal angle. Typically, these angles are decomposed into their two Cartesian components, slope in x and slope in y referred to as surface gradient maps.

Once the entire artifact has been scanned a check is made to determine if a photometric stereo or structured light method was used 450. If photometric stereo, then the gradient map pairs can be integrated 460 (literally, in the mathematical sense) to provide an estimate of the local height, i.e., the artifact's shape. The same illuminators used to acquire the conventional imagery can also be used to acquire a photometric stereo image sequence.

With respect to the structured light method, a light pattern is projected onto the artifact (typically a single line, but possibly a grid) and an image is acquired. The light can be projected at one angle while the camera view can be from another angle. With knowledge of these two angles, local height information can be inferred. This type of three-dimensional data acquisition can be accomplished using the same CCD camera as above and a minor modification to (or augmentation of) the illuminators used for the conventional imagery and photometric stereo. No integration of the structured light measurements are necessary.

All of the above imaging techniques using the CCD camera use a telecentric imaging system. Based on typical CCD camera pixel sizes of 7 μm or so, a ¼ X telecentric lens will provide a resolution of 28 μm, and an artifact field on the order of one-inch square. The size of this sub-image of the object dictates the required number of images required to characterize the entire artifact. For instance, Cuneiform tablets range in size from the size of one's thumb to the size of one's chest. The total number of sub-images might therefore range from a few to a couple hundred.

The above methods of acquiring three-dimensional data are very fast but do not possess the best ability to discern height. For that the present invention relies on an amplitude modulated laser range sensor. This concept measures range to a single point on the surface of the object. Positioning of this range measurement beam is illustrated in the drawing as being accomplished using a galvanometer mirror, but it can also be done using acousto-optic Bragg cells. The latter technology has the advantage that it is faster than mechanical galvanometers.

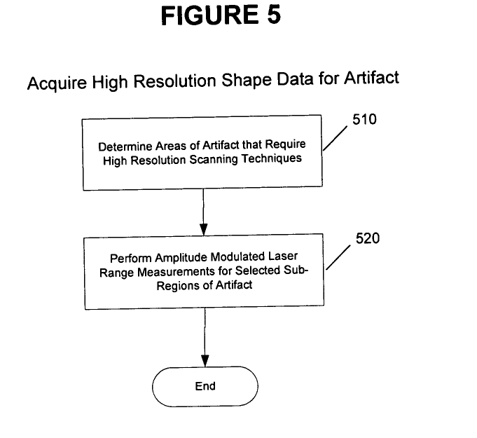

FIG. 5 is a flow chart describing the high resolution image data acquisition process in greater detail. The first step is to determine the areas of the artifact that need imaging in greater resolution 510. This is determined by computer software algorithms that analyze the gross shape data. The artifact is then positioned accordingly on the platen and an amplitude modulated laser measurement is taken 520 for the selected region of the artifact.

There are also two mutually exclusive methods that can be used for taking the amplitude modulated laser measurements. One is to use a galvanometer mirror and galvanometer control subsystem. These components have been illustrated in FIG. 1. The other method is to use acousto-optic Bragg cells and a corresponding control sub-system in place of the galvanometer mirrors and galvanometer control subsystem. The acousto-optic Bragg cell method performs faster than the mechanical galvanometer method.

In the following claims, any means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A method of scanning an artifact comprising:
obtaining color image data for the artifact using conventional imagery;
obtaining gross shape data for the artifact using a three-dimensional scanning technique;
determining areas on the artifact that need to be scanned in a higher resolution; and
obtaining high resolution shape data for the areas on the artifact determined to need higher resolution using an amplitude modulated laser scanning technique.

2. The method of claim 1 further comprising combining the color image data, gross shape data, and high resolution shape data into a single image file representative of the artifact.

3. The method of claim 1 wherein obtaining gross shape data for the artifact using a three-dimensional scanning technique is achieved using a photometric stereo scanning technique.

4. The method of claim 1 wherein obtaining gross shape data for the artifact using a three-dimensional scanning technique is achieved using a structured light scanning technique.

5. The method of claim 1 wherein obtaining high resolution shape data for the artifact using amplitude modulated laser scanning technique is achieved by a galvanometer based system.

6. The method of claim 1 wherein obtaining high resolution shape data for the artifact using amplitude modulated laser scanning technique is achieved by an acousto-optic Bragg cell system.

7. A system for scanning an artifact comprising:
a software controlled processor for operating the scanning system;
a CCD coupled with the processor for obtaining color image data; gross shape data; and high resolution shape data for the artifact;
at least one color illumination projector coupled with the processor for illuminating the artifact with colored light;
at least one pattern illumination projector coupled with the processor for illuminating the artifact with light for obtaining gross shape data for the artifact using a three-dimensional scanning technique;
an amplitude modulated laser scanning device coupled with the processor for obtaining high resolution shape data for the areas on the artifact determined to need higher resolution; and
optical lenses for focusing a range scanning beam emitted from the amplitude modulated laser scanning device onto the artifact.

8. The system of claim 7 wherein the processor combines the color image data, gross shape data, and high resolution shape data into a single image file representative of the artifact.

9. The system of claim 7 wherein the gross shape data for the artifact is obtained using a photometric stereo three-dimensional scanning technique.

10. The system of claim 7 wherein the gross shape data for the artifact is obtained using a structured light three-dimensional scanning technique.

11. The system of claim 7 wherein the high resolution shape data for the artifact is obtained using a galvanomter based amplitude modulated laser scanning technique.

12. The system of claim 7 wherein the high resolution shape data for the artifact is obtained using an acousto-optic Bragg cell amplitude modulated laser scanning technique.

13. A system for scanning an artifact comprising:
means for obtaining color image data for the artifact using conventional imagery;
means for obtaining gross shape data for the artifact using a three-dimensional scanning technique;
means for determining areas on the artifact that need to be scanned in a higher resolution; and
means for obtaining high resolution shape data for the areas on the artifact determined to need higher resolution using an amplitude modulated laser scanning technique.

14. The system of claim 13 further comprising means for combining the color image data, gross shape data, and high resolution shape data into a single image file representative of the artifact.

15. The system of claim 13 wherein the means for obtaining gross shape data for the artifact using a three-dimensional scanning technique is achieved using a photometric stereo scanning technique.

16. The system of claim 13 wherein the means for obtaining gross shape data for the artifact using a three-dimensional scanning technique is achieved using a structured light scanning technique.

17. The system of claim 13 wherein the means for obtaining high resolution shape data for the artifact using amplitude modulated laser scanning technique is achieved by a galvanometer based system.

18. The system of claim 13 wherein the means for obtaining high resolution shape data for the artifact using amplitude modulated laser scanning technique is achieved by an acousto-optic Bragg cell system.
